(19) United States
(12) Patent Application Publication
(10) Pub. No.: US 2026/0330826 A1
(43) Pub. Date: Oct. 22, 2026

(54) WALL RECOGNITION METHOD FOR SONAR IMAGE, ELECTRONIC DEVICE, AND NON-TRANSITORY COMPUTER-READABLE STORAGE MEDIUM

(71) Applicants: Zhejiang Ocean University, Zhoushan (CN); Haizhuoke ( Zhejiang Free Trade Zone ) Technology Co., Ltd., Zhoushan (CN)

(72) Inventors: Chengyuan Wen, Zhoushan (CN); Jianzhe Sun, Zhoushan (CN); Yunfeng Tang, Zhoushan (CN); Zheng Su, Zhoushan (CN); Yeyi Si, Zhoushan (CN); Wenhui Qiu, Zhoushan (CN); Jiaqi Cai, Zhoushan (CN); Jia Liu, Zhoushan (CN); Hanhao Zhu, Zhoushan (CN); Kun Yang, Zhoushan (CN)

(21) Appl. No.: 19/537,679

(22) Filed: Feb. 12, 2026

Related U.S. Application Data
(63) Continuation of application No. PCT/CN2025/091509, filed on Apr. 27, 2025.

(30) Foreign Application Priority Data
Apr. 18, 2025 (CN) 202510487663.9

(51) Int. Cl. G06V 20/10; G06N 3/0464; G06N 3/08; G06V 10/82

(52) U.S. Cl. CPC G06V 20/176; G06N 3/0464; G06N 3/08; G06V 10/82

(57) ABSTRACT

This application relates to the field of sonar technology and discloses a wall recognition method and system for a sonar image, a device, and a storage medium. The method includes: inputting target sonar image data into a pre-trained anomaly detection model for classification prediction of whether each pixel is corresponding to a wall, to obtain a wall recognition result, where training steps for the anomaly detection model include: acquiring training data, using the training data to train an initial model for classification prediction of whether each pixel is corresponding to a wall, to obtain the anomaly detection model, where an anomaly detection network based on a convolutional neural network (CNN) is used for the initial model, and the training data includes sonar image sample data and a target label matrix. accurate presentation of various wall details, and improved wall recognition accuracy.

### CROSS-REFERENCE TO RELATED APPLICATIONS

The present application is a continuation-application of International (PCT) Patent Application No. PCT/CN2025/091509, filed on April 27, 2025, which claims priority to Chinese Patent Application No. 202510487663.9, filed on April 18, 2025 the entire contents of which are hereby incorporated by reference in its entirety.

### TECHNICAL FIELD

This application relates to the fields of sonar technology and artificial intelligence, and in particular to a wall recognition method and system for a sonar image, a device, and a non-transitory computer-readable storage medium.

### BACKGROUND

A sonar detection technology is widely used in underwater environmental monitoring and obstacle detection. The technology emits and receives a reflected signal, and generates an image representing an underwater object based on the reflected signal. Variations in grayscale values within the image can be used to recognize various underwater targets. However, the complexity of an underwater environment leads to interference in a sonar image from factors such as noise and blurring, resulting in unstable image quality during wall recognition and making wall localization and detection difficult. In recent years, a convolutional neural network (CNN) has shown significant development in a field of image recognition and has been applied to sonar image processing for wall detection, as the CNN can automatically extract image features and enable more accurate detection. However, a bounding box is used in a current CNN-based wall recognition method to mark a wall location. This method can only label a wall roughly and cannot accurately represent a contour and details of a wall with a complex shape, resulting in low accuracy of a wall recognition result.

### SUMMARY

Based on this, to resolve the technical problem that a bounding box is used to label a wall location in an existing CNN-based wall recognition method, which can only provide rough labeling and cannot accurately present a contour and details of a wall with a complex shape, leading to low accuracy of a wall recognition result, this application proposes a wall recognition method and system for a sonar image, a device, and a storage medium.

In a first aspect, a wall recognition method for a sonar image is provided, including:
acquiring target sonar image data; and
inputting the target sonar image data into a pre-trained anomaly detection model for classification prediction of whether each pixel is corresponding to a wall, to obtain a wall recognition result,
where training steps for the anomaly detection model include: acquiring training data, using the training data to train an initial model for classification prediction of whether each pixel is corresponding to a wall, to obtain the anomaly detection model, where an anomaly detection network based on a CNN is used for the initial model, and the training data includes sonar image sample data and a target label matrix. Further, before the step of acquiring training data, the following steps are also included: acquiring sonar echo signal sample data; based on the sonar echo signal sample data, performing two-dimensional image matrix reshaping, normalization processing, jet color map processing, and visualization, and obtaining an anomaly point label based on the visualization, to obtain a wall coordinate set corresponding to each wall; generating a higher-order polynomial equation based on each wall coordinate set; generating a two-dimensional label matrix based on the sonar echo signal sample data and each higher-order polynomial equation; and performing label expansion on the two-dimensional label matrix to obtain the target label matrix.

Further, the initial model sequentially includes: an input layer, at least two feature extraction units, a feature fusion unit, a decoding unit, and a classification unit, where each of the feature extraction units is arranged in parallel;
the feature extraction unit sequentially includes: a first convolutional layer, a first activation layer, a first batch normalization layer, a first max pooling layer, a second convolutional layer, a second activation layer, a second batch normalization layer, and a second max pooling layer; and
the decoding unit sequentially includes: a first deconvolutional layer, a third activation layer, a third batch normalization layer, and a second deconvolutional layer.

Further, there are feature extraction units;
in a first feature extraction unit, both the first convolutional layer and the second convolutional layer have convolution kernel sizes of 3×3;
in a second feature extraction unit, the first convolutional layer has a convolution kernel size of 7×7, and the second convolutional layer has a convolution kernel size of 3×3;
in a third feature extraction unit, the first convolutional layer has a convolution kernel size of 15×15, and the second convolutional layer has a convolution kernel size of 5×5;
in a fourth feature extraction unit, the first convolutional layer has a convolution kernel size of 25×25, and the second convolutional layer has a convolution kernel size of 7×7; and
both the first deconvolutional layer and the second deconvolutional layer have convolution kernel sizes of 2×2.

Further, the higher-order polynomial equation is the quartic polynomial equation.

Further, the step of generating a two-dimensional label matrix based on the sonar echo signal sample data and each higher-order polynomial equation includes:
traversing all data points in the sonar echo signal sample data using a double-loop traversal method, and calculating an absolute value of a difference between a y-axis coordinate of a corresponding position of each data point and each equation value corresponding to the data point, to obtain a target distance, where the equation value is calculated by substituting an x-axis coordinate of the corresponding position of the data point into the higher-order polynomial equation; and
if the data point has a target distance less than a preset threshold, setting a label value corresponding to the data point in the two-dimensional label matrix to a first value; or
if the data point does not have a target distance less than a preset threshold, setting a label value corresponding to the data point in the two-dimensional label matrix to a second value.

Further, after the step of acquiring sonar echo signal sample data, the method further includes:
performing three-dimensional image reshaping on the sonar echo signal sample data to obtain sample data to be processed; and
performing geometric transformations and Gamma correction on the sample data to be processed to obtain the sonar image sample data.

In a second aspect, a wall recognition system for a sonar image is provided, including: an electronic device, configured to implement the steps of the above wall recognition method for a sonar image described in any of the above.

In a third aspect, an electronic device is provided, including a memory, a processor, and a computer program stored in the memory and executable on the processor, where when the processor executes the computer program, the steps of the wall recognition method for a sonar image described in any of the above are implemented.

In a fourth aspect, a computer-readable storage medium is provided, and the computer-readable storage medium stores a computer program, where when the computer program is executed by a processor, the steps of the wall recognition method for a sonar image described in any of the above are implemented.

In the wall recognition method and system for a sonar image, the device, and the storage medium in this application, the target sonar image data is acquired and input into the pre-trained anomaly detection model for pixel-level wall classification prediction, so that the wall recognition result is obtained. The anomaly detection model is obtained by using the anomaly detection network based on the CNN and is trained using training data including the sonar image sample data and the target label matrix. In traditional bounding box methods, a wall can only be labeled roughly, and a contour and details of a wall with a complex shape cannot be accurately presented. In contrast, the anomaly detection model in this application directly performs classification recognition of whether each pixel is corresponding to a wall. This pixel-level classification enables more precise wall recognition, meaning that in case of a complex underwater wall structure, this application can overcome limitations of the traditional bounding box methods, delineate a wall contour more finely, accurately present various wall details, and improve the accuracy of wall recognition.

### BRIEF DESCRIPTION OF THE DRAWINGS

FIG. 1 is an application environment diagram of a wall recognition method for a sonar image according to one embodiment;

FIG. 2 is a flowchart of the wall recognition method for a sonar image according to one embodiment;

FIG. 3 is a flowchart of the wall recognition method for a sonar image according to one embodiment;

FIG. 4 is a flowchart of the wall recognition method for a sonar image according to one embodiment;

FIG. 5 is a schematic diagram of a network structure of an initial model according to this application;

FIG. 6 is a correspondence diagram between sonar image sample data and a target label matrix according to this application; and

FIG. 7 is a structural block diagram of an electronic device according to one embodiment.

### DESCRIPTION OF THE EMBODIMENTS

The following clearly and completely describes technical solutions in embodiments of this application with reference to accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

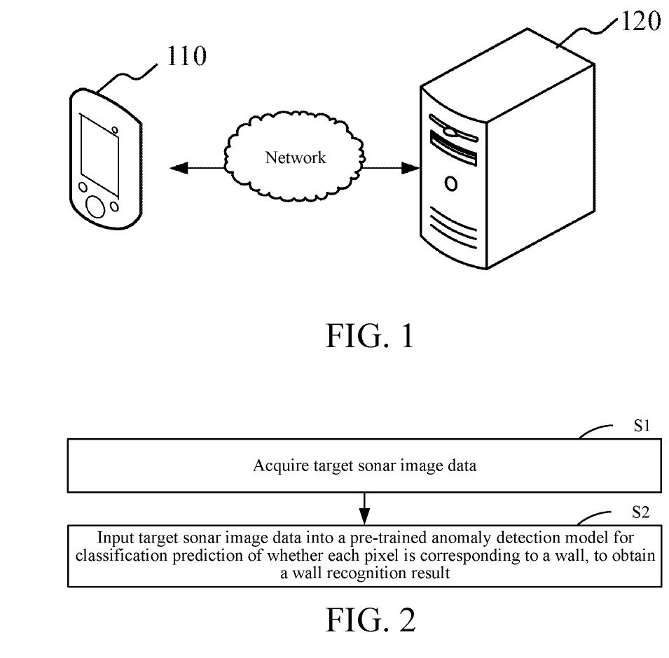

A wall recognition method for a sonar image provided in an embodiment of this application can be applied in an application environment shown in FIG. 1, where a client 110 communicates with a server 120 via a network.

The server 120 is configured to implement steps of the wall recognition method for a sonar image according to this application: acquiring target sonar image data via the client 110; and inputting the target sonar image data into a pre-trained anomaly detection model for classification prediction of whether each pixel is corresponding to a wall, to obtain a wall recognition result, where training steps for the anomaly detection model include: acquiring training data, using the training data to train an initial model for classification prediction of whether each pixel is corresponding to a wall, to obtain the anomaly detection model, where an anomaly detection network based on a CNN is used for the initial model, and the training data includes sonar image sample data and a target label matrix. The target sonar image data is acquired and input into the pre-trained anomaly detection model for pixel-level wall classification prediction, so that the wall recognition result is obtained. The anomaly detection model is obtained by using the anomaly detection network based on the CNN and is trained using the training data including the sonar image sample data and the target label matrix. In traditional bounding box methods, a wall can only be labeled roughly, and a contour and details of a wall with a complex shape cannot be accurately presented. In contrast, the anomaly detection model in this application directly performs classification recognition of whether each pixel is corresponding to a wall. This pixel-level classification enables more precise wall recognition, meaning that in case of a complex underwater wall structure, this application can overcome limitations of the traditional bounding box methods, delineate a wall contour more finely, accurately present various wall details, and improve the accuracy of wall recognition.

The client 110 (namely, an electronic device) may include, but is not limited to, various personal computers, laptops, smartphones, tablets, and portable wearable devices. The server 120 (namely, an electronic device) may be implemented using a standalone server or a server cluster including multiple servers. To be specific, both the client 110 and the server 120 may be computer devices.

The following provides a detailed description of this application through specific embodiments.

FIG. 2 shows a schematic flow diagram of a wall recognition method for a sonar image according to an embodiment of this application, including the following steps.

S1: Acquire target sonar image data.

First, a sonar detection device is used to perform sonar scanning on a target underwater environment, then three-dimensional image reshaping is performed on scanned sonar echo signal data, and a reshaped image is used as the target sonar image data.

The target underwater environment is an underwater environment where wall recognition is desired.

The sonar echo signal data is a .dat file, which includes an echo intensity at each location point (also referred to as a data point) in the target underwater environment. To be specific, the sonar echo signal data is one-dimensional data.

It can be understood that pixel points in the target sonar image data are in a one-to-one correspondence with data points in the sonar echo signal data.

It can be understood that during three-dimensional image reshaping, content of the data is essentially unchanged, only data dimensionality is increased. A specific implementation method for three-dimensional image reshaping can be selected from existing technologies and is not described herein again.

Specifically, the target sonar image data input by a user may be acquired on the client, acquired from preset storage space, or sent from a third-party application.

S2: Input the target sonar image data into a pre-trained anomaly detection model for classification prediction of whether each pixel is corresponding to a wall, to obtain a wall recognition result.

Specifically, the target sonar image data is input into the pre-trained anomaly detection model for classification prediction of whether each pixel is corresponding to a wall, and a resulting vector obtained from the classification prediction is used as the wall recognition result.

Each vector value in the wall recognition result is a probability value for corresponding to a wall.

It can be understood that a vector value at an i-th row and j-th column in the wall recognition result and a pixel value at an i-th row and j-th column in the target sonar image data are corresponding to the same location point, where both i and j are positive integers greater than zero.

Training steps for the anomaly detection model include: acquiring training data, using the training data to train an initial model for classification prediction of whether each pixel is corresponding to a wall, to obtain the anomaly detection model, where an anomaly detection network based on a CNN is used for the initial model, and the training data includes sonar image sample data and a target label matrix.

The anomaly detection model is a model for an anomaly detection task. The anomaly detection task is a supervised learning task (namely, the sonar image sample data is used as an input form the model, the target label matrix is used as a supervised target, and an output from the initial model is trained to increasingly approximate the target label matrix). The supervised learning task is related to recognition of a data point, in the data, that is anomalous (namely, a data point corresponding to the wall). Anomaly detection tasks can be divided into binary classification and multi-class classification. In binary classification, data is typically divided into an anomaly class (wall) and a normal class (an environment outside the wall). To be specific, the training data is used to train the initial model for classification prediction of whether each pixel is corresponding to a wall, which is to train a classification model. A specific training method can be selected from existing technologies and is not described herein again.

The target label matrix is a three-dimensional matrix. An element value (also referred to as a label value) in the target label matrix is corresponding to a data point that is a wall when the element value is a first value, or is corresponding to a data point that is not the wall when the element value is a second value.

An element value in an m-th row and k-th column of the target label matrix and a pixel value in an m-th row and k-th column of the sonar image sample data are corresponding to the same position, where both m and k are positive integers greater than 0.

It can be understood that the training data is used to train the initial model for classification prediction of whether each pixel is corresponding to a wall. Upon completion of training, a trained initial model is used as the anomaly detection model.

In this embodiment, the target sonar image data is acquired and input into the pre-trained anomaly detection model for pixel-level wall classification prediction to obtain the wall recognition result. The anomaly detection model is obtained by using the anomaly detection network based on the CNN and is trained with the training data including the sonar image sample data and the target label matrix. In traditional bounding box methods, a wall can only be labeled roughly, and a contour and details of a wall with a complex shape cannot be accurately presented. In contrast, the anomaly detection model in this application directly performs classification recognition of whether each pixel is corresponding to a wall. This pixel-level classification enables more precise wall recognition, meaning that in case of a complex underwater wall structure, this application can overcome limitations of the traditional bounding box methods, delineate a wall contour more finely, accurately present various wall details, and improve the accuracy of wall recognition.

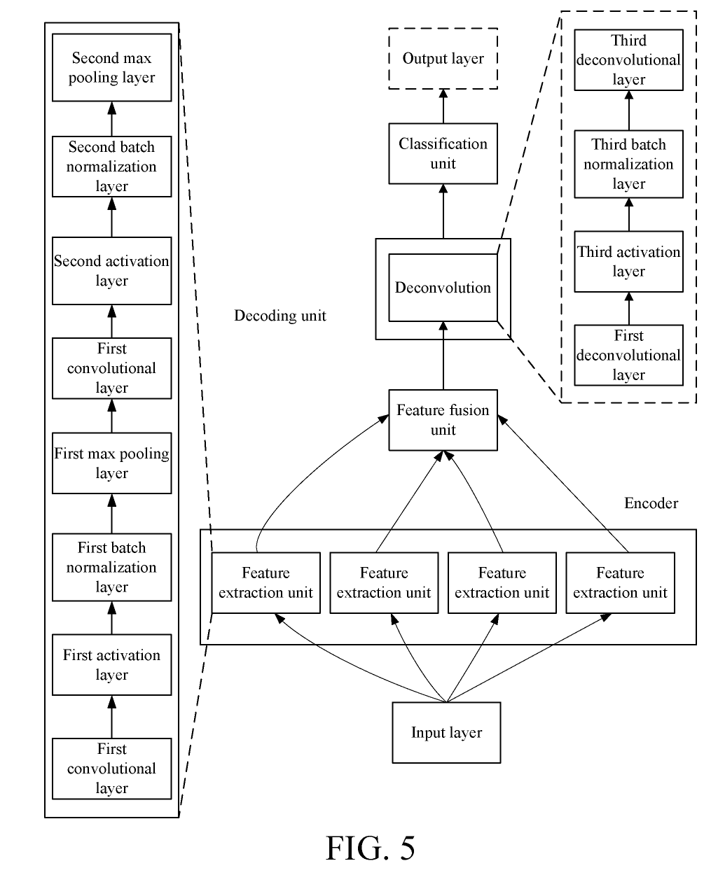

Refer to FIG. 5. In one embodiment, the initial model sequentially includes: an input layer, at least two feature extraction units, a feature fusion unit, a decoding unit, and a classification unit, where each of the feature extraction units is arranged in parallel.

The feature extraction unit sequentially includes: a first convolutional layer, a first activation layer, a first batch normalization layer, a first max pooling layer, a second convolutional layer, a second activation layer, a second batch normalization layer, and a second max pooling layer.

The decoding unit sequentially includes: a first deconvolutional layer, a third activation layer, a third batch normalization layer, and a second deconvolutional layer.

The input layer is used to receive data input into the initial model, and then input the received data into each of the feature extraction units.

Each of the feature extraction units forms an encoder. Each of the feature extraction units performs feature extraction at different scales.

The feature fusion unit is configured to concatenate features extracted by each of the feature extraction units in a channel dimension to form a feature map that fuses multi-scale features, and inputs the feature map into the decoding unit.

For example, if there are four feature extraction units, the feature fusion unit concatenates four feature maps (each feature extraction unit outputs one feature map) in the dimension. A specific principle is as follows: concatenation is performed in the channel dimension: in a NCHW (N: batch size; C: the number of channels; H: a height of the feature map; W: a width of the feature map) format of PyTorch (PyTorch is an open-source deep learning framework for machine learning and deep learning, when concatenation is performed by using torch.cat (a function used for tensor concatenation) in the channel dimension (dim=1), it is necessary to ensure that all dimensions except the number of channels are the same; otherwise, direct concatenation is not possible. Only when N, H/4, and W/4 dimensions are exactly the same can cat (concatenation) be performed smoothly along a first dimension (the channel dimension). A first feature extraction unit and a second feature extraction unit have 128 dimensions each, while a third feature extraction unit and a fourth feature extraction unit have 64 dimensions each. Therefore, after concatenation, there are 384 channels (namely, the feature fusion unit inputs data in 384 channels). To be specific, the feature fusion unit implements the fusion of parallel features.

In the field of machine learning and deep learning, a batch size means the number of data samples used to train a model in one iteration.

From a data structure perspective, the aggregation of the parallel features means a 'horizontal expansion' in the channel direction through concatenation, allowing each convolution kernel in a subsequent network to access features from different branches. It can be understood that the network has previously divided the image into multiple branches with different receptive fields (each feature extraction unit serves as a branch), and each of the feature extraction units follows a self-convolution and pooling path, and then 'merges' at the same depth level before entering the decoding unit.

The decoding unit is configured to decode the feature map input from the feature fusion unit and ultimately outputs a single-channel image.

The classification unit is a fully connected layer with a Sigmoid activation function. The classification unit is configured to perform classification based on an input from the decoding unit.

The Sigmoid activation function is a commonly known S-shaped function in biology, also known as an S-shaped growth curve. In information science, due to monotonic increase and the monotonicity of an inverse function, the Sigmoid activation function is usually used as an activation function in a neural network to map a variable to between 0 and 1.

Both the first convolutional layer and the second convolutional layer are convolutional layers.

The first activation layer, the second activation layer, and the third activation layer are all rectified linear unit (ReLU) activation functions.

The ReLU activation function is one of the most commonly used activation functions in the CNN and multiple deep learning models. A main function of the ReLU activation function is to introduce nonlinearity, enabling a model to learn and represent a more complex feature.

Features extracted by the feature extraction unit, after being processed by the ReLU activation function, can map linearly inseparable data to new space, allowing the initial model to learn a more complex pattern and relationship, thereby enhancing a nonlinear representation capability of the model.

The first batch normalization layer, the second batch normalization layer, and the third batch normalization layer are all batch normalization layers.

The first max pooling layer and the second max pooling layer are both max pooling layers. During the operation of the initial model, the max pooling layer gradually reduces a spatial dimension of the feature map. This operation directly reduces computational load, as a smaller size of the feature map means an input scale for a subsequent layer is reduced, thereby decreasing the amount of computation for a connection weight between neurons. In addition, this simplification for the feature map helps prevent overfitting by removing some local details and noise from the data, preventing excessive reliance of the model on a special case in the training data, and thus improving a generalization capability of the model. More importantly, when reducing the spatial dimension of the feature map, the max pooling layer retains the most prominent feature by selecting a maximum value within a local region, preserving the most representative feature information in each local region. These retained significant features are crucial for accurate analysis, recognition, or classification tasks in a subsequent processing layer, laying a foundation for efficient and accurate operation of the entire model.

Both the first deconvolutional layer and the second deconvolutional layer are deconvolutional layers, which are also known as transposed convolutional layers. The deconvolutional layers gradually restore spatial resolution of the image, ensuring that image details are recovered.

Through this multi-branch design (with each feature extraction unit as a branch) for multi-scale feature extraction, the multi-branch design can effectively fuse image features of different scales, enabling the initial model to learn and enhance detail information from a complex image, and ultimately output an enhanced image that enables the wall to be more prominent and improves detectability of the wall. This design has an advantage of being capable of effectively addressing challenges of complex backgrounds and multi-scale features, and is particularly suitable for tasks related to sonar image sample data, which usually contain substantial background noise and target variability.

Optionally, a convolution kernel size of each first convolutional layer is different.

It can be understood that, after the first convolutional layer in the feature extraction unit, the first activation layer, the first batch normalization layer, and the first max pooling layer are connected sequentially to gradually extract image features and reduce spatial resolution.

Through improvements to the model in this embodiment, an improved initial model can delineate a wall contour in greater detail and accurately present various wall details. The initial model can maintain high recognition accuracy in application scenarios with substantial noise and poor image quality in an underwater environment, offering greater robustness than traditional methods and being capable of meeting challenges of complex underwater conditions.

In one embodiment, there are four feature extraction units.

In a first feature extraction unit, both the first convolutional layer and the second convolutional layer have convolution kernel sizes of 3×3;

in a second feature extraction unit, the first convolutional layer has a convolution kernel size of 7×7, and the second convolutional layer has a convolution kernel size of 3×3;

in a third feature extraction unit, the first convolutional layer has a convolution kernel size of 15×15, and the second convolutional layer has a convolution kernel size of 5×5;

in a fourth feature extraction unit, the first convolutional layer has a convolution kernel size of 25×25, and the second convolutional layer has a convolution kernel size of 7×7; and

both the first deconvolutional layer and the second deconvolutional layer have convolution kernel sizes of 2×2.

The first convolutional layer of the first feature extraction unit is used to extract an edge of the wall; the first convolutional layer of the second feature extraction unit is used to capture a local shape; the first convolutional layer of the third feature extraction unit is used to extract a contour and complex structure of a corresponding region of the wall; and the first convolutional layer of the fourth feature extraction unit is used to obtain an overall shape and background information of the wall. To be specific, small-sized convolution kernels (3×3) extract low-level detail features of the image, such as wall edges; medium-small-sized convolution kernels (7×7) capture local shapes of the wall; medium-large-sized convolution kernels (15×15) extract contours and object structures of corresponding regions of the wall; and large-sized convolution kernels (25×25) extract global features, such as a general shape and background information of the wall. These features are integrated through the feature fusion unit, and the initial model can comprehensively analyze multi-scale information in the image, from local details of the wall to an overall structure (such as the wall contour), thereby implementing accurate detection and recognition of the wall.

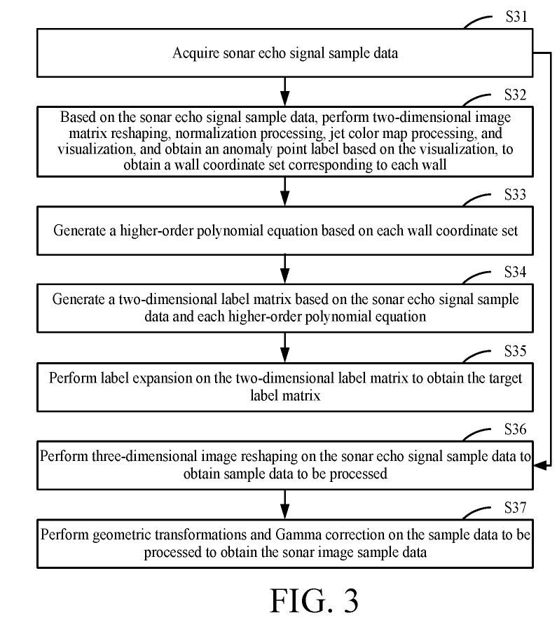

Refer to FIG. 3. In one embodiment, before the step of acquiring training data, the following steps are also included.

S31: Acquire sonar echo signal sample data.

A sonar detection device is used to scan the underwater environment, and scanned sonar echo signal data is used as the sonar echo signal sample data.

Specifically, the sonar echo signal sample data input by a user can be acquired via a client, acquired from preset storage space, or sent from a third-party application.

S32: Based on the sonar echo signal sample data, perform two-dimensional image matrix reshaping, normalization processing, jet color map processing, and visualization, and obtain an anomaly point label based on the visualization, to obtain a wall coordinate set corresponding to each wall.

A jet color map is a commonly used color mapping in the field of data visualization. The jet color map includes a continuous color transition from blue through green and red to yellow. The jet color map typically maps a range of data values to this color range, with a greater value corresponding to the blue end, a smaller value to the yellow end, and intermediate values distributed in the green region and red region. The jet color map is designed to provide an intuitive way to represent a range of data variation. Different colors are used, so that human eyes can more easily distinguish between different value ranges in the data, helping people quickly understand distribution and a variation trend of the data.

Specifically, two-dimensional image matrix reshaping is performed based on the sonar echo signal sample data, reshaped data is normalized, and normalized data is enhanced for reflection intensity visibility using the jet color map. The two-dimensional image matrix reshaping and normalization processing ensure that the data is adapted for subsequent processing and that the initial model can learn stably during training, preventing the impact of differences in data size and range on the performance of the initial model.

The sonar echo signal sample data is subjected to the two-dimensional image matrix reshaping and normalization processing to ensure stable operation of the data in subsequent steps. Through matrix reshaping, the sonar echo signal sample data is converted from a one-dimensional vector to a two-dimensional image matrix (for example, if original data contains 100 frames, there are 30,720,000 data points in total, which are reshaped into 100*600*512, namely, 100 two-dimensional image matrices), facilitating subsequent image processing and feature extraction. The normalization processing ensures the consistency of data scale, preventing a negative impact of different data scales on initial model training.

Data processed by the jet color map is displayed on an interface for visualization.

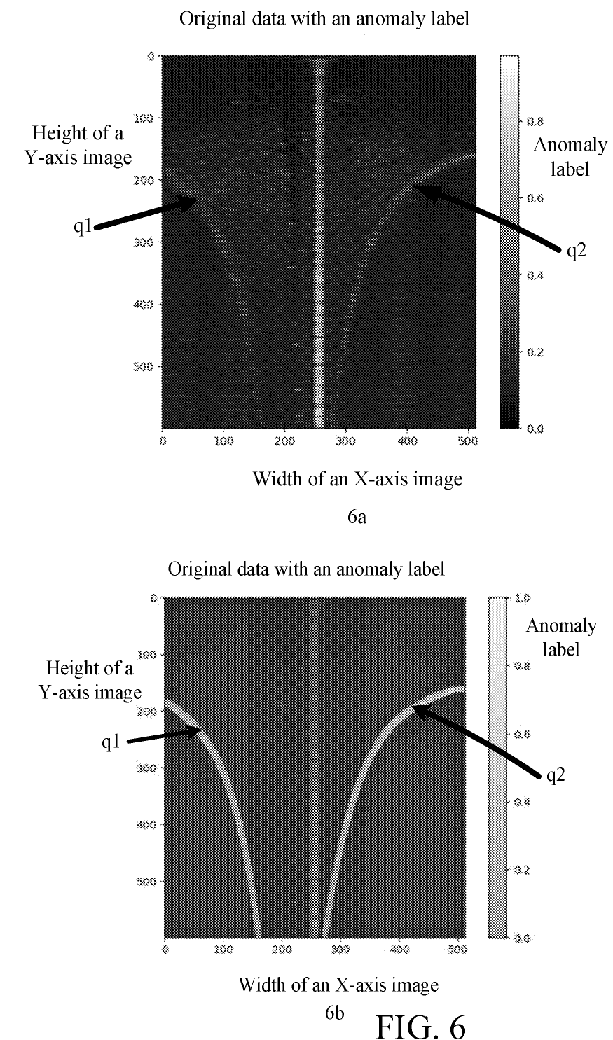

For example, as shown in FIG. 6, subfigure 6a in FIG. 6 is a visualization image of data input into the initial model, and subfigure 6b in FIG. 6 is a visualization image of the data processed by the jet color map displayed on the interface. Both 6a and 6b show wall q1 and wall q2.

Specific steps for obtaining an anomaly point label for each wall based on visualization include: according to content displayed on the interface, when a region is considered anomalous (namely, a wall), performing interactive labeling through a mouse, recording a start position when pressing the mouse, and initializing a coordinate record; when dragging the mouse, recording a current mouse position, and updating a coordinate list; and when releasing the mouse, saving all recorded coordinate points. It should be noted that if the mouse is pressed again, a previously recorded coordinate list is cleared. Finally, all coordinate points are saved in a text file with a simple format, where each line records one coordinate point (x, y). This text file serves as the wall coordinate set corresponding to the wall.

For example, if two regions in an acquired image are considered anomalous (namely, walls), the mouse should first always be dragged within one of the two regions, and as many coordinates as possible need to be recorded while accuracy is ensured. After completion, a file save path needs to be modified, and the file is used as one wall coordinate set. Then, a program is rerun, the mouse is dragged within the other region, and as many coordinates as possible are recorded while accuracy is ensured. After completion, a file save path needs to be modified, and the file is used as the other wall coordinate set.

S33: Generate a higher-order polynomial equation based on each wall coordinate set.

Specifically, one higher-order polynomial equation is fitted for each wall coordinate set.

The higher-order polynomial equation may be a quadratic polynomial equation, a cubic polynomial equation, or a quartic polynomial equation. To be specific, the higher-order polynomial equation in this application is a polynomial equation of at least second order.

Because the wall is relatively regular and has a relatively fastened position, the fitted higher-order polynomial equation is used to represent the wall.

S34: Generate a two-dimensional label matrix based on the sonar echo signal sample data and each higher-order polynomial equation.

Specifically, all data points are traversed using the higher-order polynomial equations of all walls to generate the two-dimensional label matrix. An element value in the two-dimensional label matrix is either a first value or a second value. The first value represents an anomaly point (a data point corresponding to a wall), and the second value represents a normal point (a data point corresponding to a background outside the wall).

S35: Perform label expansion on the two-dimensional label matrix to obtain the target label matrix.

Specifically, label expansion is used to adjust a tensor dimension of the two-dimensional label matrix, so that the target label matrix obtained after label expansion matches a shape of data of the input initial model data. This allows the initial model to perform a comparison based on an image and a label value (an element value in the two-dimensional label matrix) during training.

In this embodiment, a shape and an edge of the wall are accurately displayed through color labeling (namely, jet color map processing), preventing a drawback of traditional box marking methods which cannot finely depict wall details. This not only improves recognition accuracy but also enhances a visualization effect of a result.

In one embodiment, the higher-order polynomial equation is the quartic polynomial equation.

For example, for wall q1 in FIG. 6, a fitted quartic polynomial equation is:

For wall q2 in FIG. 6, a fitted quartic polynomial equation is: , where x is an x-axis coordinate of a data point.

It can be understood that an order in the quartic polynomial equation means the highest power of x.

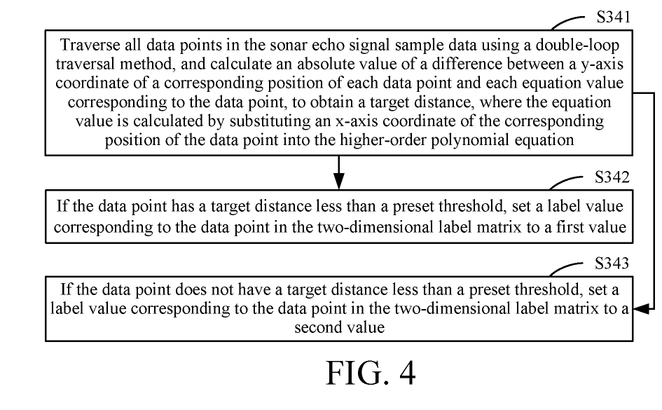

Refer to FIG. 4. In one embodiment, the step of generating a two-dimensional label matrix based on the sonar echo signal sample data and each higher-order polynomial equation includes the following substeps.

S341: Traverse all data points in the sonar echo signal sample data using a double-loop traversal method, and calculate an absolute value of a difference between a y-axis coordinate of a corresponding position of each data point and an equation value corresponding to the data point, to obtain a target distance, where the equation value is calculated by substituting an x-axis coordinate of the corresponding position of the data point into the higher-order polynomial equation.

Specifically, the double-loop traversal method is used to traverse all data points in the sonar echo signal sample data. The y-axis coordinate of the corresponding position of the data point is subtracted from the equation value calculated by substituting the x-axis coordinate of the corresponding position of the data point into the higher-order polynomial equation, and an absolute value of data obtained through subtraction is taken as the target distance.

That is, for each data point, a target distance is calculated for each higher-order polynomial equation.

S342: If the data point has a target distance less than a preset threshold, set a label value corresponding to the data point in the two-dimensional label matrix to a first value.

Specifically, if the data point has the target distance less than the preset threshold, this means the data point is corresponding to a wall. Therefore, the label value corresponding to the data point in the two-dimensional label matrix is set to the first value.

S343: If the data point does not have a target distance less than a preset threshold, set a label value corresponding to the data point in the two-dimensional label matrix to a second value.

Specifically, if the data point does not have the target distance less than the preset threshold, this means that the data point is not corresponding to a wall. Therefore, the label value corresponding to the data point in the two-dimensional label matrix is set to the second value.

Optionally, the first value is set to 1 and the second value is set to 0.

In this embodiment, the target distance is determined by calculating the absolute value of the difference between the y-axis coordinate of the corresponding position of each data point and the equation value obtained by substitution into the higher-order polynomial equation, which enables effective screening and classification of data points. When there is a data point with a target distance less than the preset threshold, a label value corresponding to the data point in the two-dimensional label matrix is set to the first value. This helps accurately label data points that fit a polynomial equation well, which may indicate that these data points conform to an expected feature or pattern. For a data point that does not have a target distance less than the preset threshold, a label value corresponding to the data point is set to the second value. This allows differentiation of a data point that does not fit the polynomial equation well, which helps distinguish different types of data points in the analysis of sonar echo signal data, such as distinguishing a signal corresponding to the wall from a signal corresponding to a point outside the wall, thereby improving understanding, analysis, and subsequent processing accuracy of the sonar echo signal data.

Refer to FIG. 3. In one embodiment, after the step of acquiring sonar echo signal sample data, the following steps are further included.

S36: Perform three-dimensional image reshaping on the sonar echo signal sample data to obtain sample data to be processed.

Specifically, first, a structure and related parameters of the sonar echo signal sample data are determined, such as the number of data points and the distribution of the data points in different dimensions. Then, according to preset rules, these discrete data points are spatially arranged, and for x, y, and z dimensions, a coordinate position of each data point in new three-dimensional space is determined. Mathematical methods such as interpolation can be used to fill in gaps between the data points to ensure the integrity and continuity of a three-dimensional image. Next, based on a characteristic of the sonar echo signal sample data, each data point is assigned a corresponding color or grayscale value to represent an attribute of an echo intensity. Finally, through specialized graphics rendering technologies and tools, these processed data points are combined to form a complete and intuitive three-dimensional image, which can visually present key features (such as distribution and echo intensity) of the sonar echo signal sample data.

S37: Perform geometric transformations and Gamma correction on the sample data to be processed to obtain the sonar image sample data.

The Geometric transformations include rotation, translation, scaling, and flipping. For example, a wall edge can be rotated by 30° using a rotation matrix to be moved to an edge of the three-dimensional image, thereby simulating different viewing angles, where cos is a cosine function, and sin is a sine function.

The Gamma correction is an image processing technology that performs nonlinear transformation on pixel values of an image to improve a display effect and visual quality of the image. The Gamma correction further enhances a brightness difference between a wall and a background by adjusting a brightness curve, thereby improving a robustness and recognition capability of the initial model in a complex scenario.

Specifically, the sample data to be processed is first subjected to the geometric transformation, and then data obtained from the geometric transformation is subjected to the Gamma correction; and data obtained from the Gamma correction is used as the sonar image sample data.

In this embodiment, the geometric transformation and Gamma correction are sequentially used in the sample data to be processed, making an originally blurred wall clear and bright after processing, while previously strong noise is suppressed.

In one embodiment, a wall recognition system for a sonar image is provided, including: an electronic device, configured to implement the steps of the wall recognition method for a sonar image described in any of the above.

In this embodiment, the target sonar image data is acquired and input into the pre-trained anomaly detection model for pixel-level wall classification prediction to obtain the wall recognition result. The anomaly detection model is obtained by using the anomaly detection network based on the CNN and is trained with the training data including the sonar image sample data and the target label matrix. In traditional bounding box methods, a wall can only be labeled roughly, and a contour and details of a wall with a complex shape cannot be accurately presented. In contrast, the anomaly detection model in this application directly performs classification recognition of whether each pixel is corresponding to a wall. This pixel-level classification enables more precise wall recognition, meaning that in case of a complex underwater wall structure, this application can overcome limitations of the traditional bounding box methods, delineate a wall contour more finely, accurately present various wall details, and improve the accuracy of wall recognition.

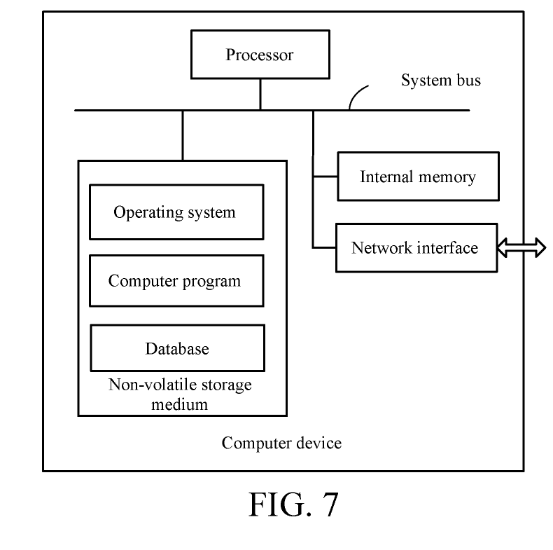

In one embodiment, a computer device is provided, which may be a server 120, with an internal structure diagram as shown in FIG. 7. The computer device includes a processor, a memory, a network interface, and a database, all connected via a system bus. The processor of the computer device is used to provide computing and control capabilities. The memory of the computer device includes a non-volatile medium and/or a volatile storage medium, and an internal memory. The non-volatile storage medium stores an operating system, a computer program, and a database. The internal memory provides an environment for running the operating system and the computer program stored in the non-volatile storage media. A network interface of the computer device is used for network communication with the external client 110. When the computer program is executed by the processor, functions or steps of the wall recognition method for a sonar image on the server 120 can be implemented.

In one embodiment, an electronic device is provided, including a memory, a processor, and a computer program stored in the memory and executable on the processor, where when the processor executes the computer program, the following steps are implemented:
acquiring target sonar image data; and
inputting the target sonar image data into a pre-trained anomaly detection model for classification prediction of whether each pixel is corresponding to a wall, to obtain a wall recognition result,
where training steps for the anomaly detection model include: acquiring training data, using the training data to train an initial model for classification prediction of whether each pixel is corresponding to a wall, to obtain the anomaly detection model, where an anomaly detection network based on a CNN is used for the initial model, and the training data includes sonar image sample data and a target label matrix.

In this embodiment, the target sonar image data is acquired and input into the pre-trained anomaly detection model for pixel-level wall classification prediction to obtain the wall recognition result. The anomaly detection model is obtained by using the anomaly detection network based on the CNN and is trained with the training data including the sonar image sample data and the target label matrix. In traditional bounding box methods, a wall can only be labeled roughly, and a contour and details of a wall with a complex shape cannot be accurately presented. In contrast, the anomaly detection model in this application directly performs classification recognition of whether each pixel is corresponding to a wall. This pixel-level classification enables more precise wall recognition, meaning that in case of a complex underwater wall structure, this application can overcome limitations of the traditional bounding box methods, delineate a wall contour more finely, accurately present various wall details, and improve the accuracy of wall recognition.

In one embodiment, a computer-readable storage medium is provided, where the computer-readable storage medium stores a computer program, and when the computer program is executed by a processor, the following steps are implemented:
acquiring target sonar image data; and
inputting the target sonar image data into a pre-trained anomaly detection model for classification prediction of whether each pixel is corresponding to a wall, to obtain a wall recognition result,
where training steps for the anomaly detection model include: acquiring training data, using the training data to train an initial model for classification prediction of whether each pixel is corresponding to a wall, to obtain the anomaly detection model, where an anomaly detection network based on a CNN is used for the initial model, and the training data includes sonar image sample data and a target label matrix.

In this embodiment, the target sonar image data is acquired and input into the pre-trained anomaly detection model for pixel-level wall classification prediction to obtain the wall recognition result. The anomaly detection model is obtained by using the anomaly detection network based on the CNN and is trained with the training data including the sonar image sample data and the target label matrix. In traditional bounding box methods, a wall can only be labeled roughly, and a contour and details of a wall with a complex shape cannot be accurately presented. In contrast, the anomaly detection model in this application directly performs classification recognition of whether each pixel is corresponding to a wall. This pixel-level classification enables more precise wall recognition, meaning that in case of a complex underwater wall structure, this application can overcome limitations of the traditional bounding box methods, delineate a wall contour more finely, accurately present various wall details, and improve the accuracy of wall recognition.

It should be noted that the functions or steps implemented by the above computer-readable storage medium or electronic device can be referenced in the relevant descriptions of the server 120 and client 110 in the preceding method embodiments, which are not described herein again.

It can be understood by a person skilled in the art that all or a part of a process in the above method embodiment can be completed by instructing related hardware through a computer program. The computer program can be stored in a non-volatile computer-readable storage medium, and when executed, the computer program may include the processes of the above method embodiments. Any reference to a memory, storage, a database, or other media used in each embodiment provided in this application may include a non-volatile and/or volatile memory. The non-volatile memory may include a Read-Only Memory (ROM), a Programmable ROM (PROM), an Electrically Programmable ROM (EPROM), an Electrically Erasable Programmable ROM (EEPROM), or a flash memory. The volatile memory may include a Random Access Memory (RAM) or an external cache memory. By way of illustration and not limitation, RAM is available in various forms, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), Rambus Direct RAM (RDRAM), Direct Rambus DRAM (DRDRAM), Rambus DRAM (RDRAM), and the like.

A person skilled in the art may clearly understand that, for ease of brief description, division into the foregoing functional units or modules is merely used as an example for description. In actual application, the foregoing functions can be allocated to different functional units or modules for implementation based on a requirement. In other words, an inner structure of the system is divided into different functional units or modules to implement all or some of the functions described above.

The above embodiments are merely intended to describe the technical solutions of this application, but are not to limit this application. Although this application is described in detail with reference to the foregoing embodiments, a person skilled in the art should understand that modifications may still be made to the technical solutions described in the above embodiments or equivalent replacements may be made to some technical features thereof, without departing from the spirit and scope of the technical solutions of embodiments of this application, and these modifications and replacements shall fall within the protection scope of this application.

What is claimed is:

1. A wall recognition method for a sonar image, comprising:
acquiring target sonar image data; and
inputting the target sonar image data into a pre-trained anomaly detection model for classification prediction of whether each pixel is corresponding to a wall, to obtain a wall recognition result,
wherein training steps for the anomaly detection model comprise: acquiring training data, using the training data to train an initial model for classification prediction of whether each pixel is corresponding to a wall, to obtain the anomaly detection model, wherein an anomaly detection network based on a convolutional neural network is used for the initial model, and the training data comprises sonar image sample data and a target label matrix;
wherein before the step of acquiring training data, the method further comprises:
acquiring sonar echo signal sample data;
based on the sonar echo signal sample data, performing two-dimensional image matrix reshaping, normalization processing, jet color map processing, and visualization, and obtaining an anomaly point label based on the visualization, to obtain a wall coordinate set corresponding to each wall;
generating a higher-order polynomial equation based on each wall coordinate set;
generating a two-dimensional label matrix based on the sonar echo signal sample data and each higher-order polynomial equation; and
performing label expansion on the two-dimensional label matrix to obtain the target label matrix.

2. The wall recognition method for a sonar image according to claim 1, wherein the initial model sequentially comprises: an input layer, at least two feature extraction units, a feature fusion unit, a decoding unit, and a classification unit, wherein each of the feature extraction units is arranged in parallel;
the feature extraction unit sequentially comprises: a first convolutional layer, a first activation layer, a first batch normalization layer, a first max pooling layer, a second convolutional layer, a second activation layer, a second batch normalization layer, and a second max pooling layer; and
the decoding unit sequentially comprises: a first deconvolutional layer, a third activation layer, a third batch normalization layer, and a second deconvolutional layer.

3. The wall recognition method for a sonar image according to claim 2, wherein there are four feature extraction units;
in a first feature extraction unit, both the first convolutional layer and the second convolutional layer have convolution kernel sizes of 3×3;
in a second feature extraction unit, the first convolutional layer has a convolution kernel size of 7×7, and the second convolutional layer has a convolution kernel size of 3×3;
in a third feature extraction unit, the first convolutional layer has a convolution kernel size of 15×15, and the second convolutional layer has a convolution kernel size of 5×5;
in a fourth feature extraction unit, the first convolutional layer has a convolution kernel size of 25×25, and the second convolutional layer has a convolution kernel size of 7×7; and
both the first deconvolutional layer and the second deconvolutional layer have convolution kernel sizes of 2×2.

4. The wall recognition method for a sonar image according to claim 1, wherein the higher-order polynomial equation is a quartic polynomial equation.

5. The wall recognition method for a sonar image according to claim 1, wherein the step of generating a two-dimensional label matrix based on the sonar echo signal sample data and each higher-order polynomial equation comprises:
traversing all data points in the sonar echo signal sample data using a double-loop traversal method, and calculating an absolute value of a difference between a y-axis coordinate of a corresponding position of each data point and each equation value corresponding to the data point, to obtain a target distance, wherein the equation value is calculated by substituting an x-axis coordinate of the corresponding position of the data point into the higher-order polynomial equation; and
if the data point has a target distance less than a preset threshold, setting a label value corresponding to the data point in the two-dimensional label matrix to a first value; or
if the data point does not have a target distance less than a preset threshold, setting a label value corresponding to the data point in the two-dimensional label matrix to a second value.

6. The wall recognition method for a sonar image according to claim 1, wherein after the step of acquiring sonar echo signal sample data, the method further comprises:
performing three-dimensional image reshaping on the sonar echo signal sample data to obtain sample data to be processed; and
performing geometric transformations and Gamma correction on the sample data to be processed to obtain the sonar image sample data.

7. A wall recognition system for a sonar image, wherein the system comprises: an electronic device, the electronic device is configured to implement the steps of the wall recognition method for a sonar image according to claim 1.

8. The wall recognition system for a sonar image according to claim 7, wherein the initial model sequentially comprises: an input layer, at least two feature extraction units, a feature fusion unit, a decoding unit, and a classification unit, wherein each of the feature extraction units is arranged in parallel;
the feature extraction unit sequentially comprises: a first convolutional layer, a first activation layer, a first batch normalization layer, a first max pooling layer, a second convolutional layer, a second activation layer, a second batch normalization layer, and a second max pooling layer; and
the decoding unit sequentially comprises: a first deconvolutional layer, a third activation layer, a third batch normalization layer, and a second deconvolutional layer.

9. The wall recognition system for a sonar image according to claim 8, wherein there are four feature extraction units;
in a first feature extraction unit, both the first convolutional layer and the second convolutional layer have convolution kernel sizes of 3×3;
in a second feature extraction unit, the first convolutional layer has a convolution kernel size of 7×7, and the second convolutional layer has a convolution kernel size of 3×3;
in a third feature extraction unit, the first convolutional layer has a convolution kernel size of 15×15, and the second convolutional layer has a convolution kernel size of 5×5;
in a fourth feature extraction unit, the first convolutional layer has a convolution kernel size of 25×25, and the second convolutional layer has a convolution kernel size of 7×7; and
both the first deconvolutional layer and the second deconvolutional layer have convolution kernel sizes of 2×2.

10. The wall recognition system for a sonar image according to claim 7, wherein the higher-order polynomial equation is a quartic polynomial equation.

11. The wall recognition system for a sonar image according to claim 7, wherein the step of generating a two-dimensional label matrix based on the sonar echo signal sample data and each higher-order polynomial equation comprises:
traversing all data points in the sonar echo signal sample data using a double-loop traversal method, and calculating an absolute value of a difference between a y-axis coordinate of a corresponding position of each data point and each equation value corresponding to the data point, to obtain a target distance, wherein the equation value is calculated by substituting an x-axis coordinate of the corresponding position of the data point into the higher-order polynomial equation; and
if the data point has a target distance less than a preset threshold, setting a label value corresponding to the data point in the two-dimensional label matrix to a first value; or
if the data point does not have a target distance less than a preset threshold, setting a label value corresponding to the data point in the two-dimensional label matrix to a second value.

12. The wall recognition system for a sonar image according to claim 7, wherein after the step of acquiring sonar echo signal sample data, the method further comprises:
performing three-dimensional image reshaping on the sonar echo signal sample data to obtain sample data to be processed; and
performing geometric transformations and Gamma correction on the sample data to be processed to obtain the sonar image sample data.

13. An electronic device, wherein the electronic device comprises a memory, a processor, and a computer program stored in the memory and executable on the processor, and when the processor executes the computer program, the steps of the wall recognition method for a sonar image according to claim 1 are implemented.

14. The electronic device according to claim 13, wherein the initial model sequentially comprises: an input layer, at least two feature extraction units, a feature fusion unit, a decoding unit, and a classification unit, wherein each of the feature extraction units is arranged in parallel;
the feature extraction unit sequentially comprises: a first convolutional layer, a first activation layer, a first batch normalization layer, a first max pooling layer, a second convolutional layer, a second activation layer, a second batch normalization layer, and a second max pooling layer; and
the decoding unit sequentially comprises: a first deconvolutional layer, a third activation layer, a third batch normalization layer, and a second deconvolutional layer.

15. The electronic device according to claim 14, wherein there are four feature extraction units;
in a first feature extraction unit, both the first convolutional layer and the second convolutional layer have convolution kernel sizes of 3×3;
in a second feature extraction unit, the first convolutional layer has a convolution kernel size of 7×7, and the second convolutional layer has a convolution kernel size of 3×3;
in a third feature extraction unit, the first convolutional layer has a convolution kernel size of 15×15, and the second convolutional layer has a convolution kernel size of 5×5;
in a fourth feature extraction unit, the first convolutional layer has a convolution kernel size of 25×25, and the second convolutional layer has a convolution kernel size of 7×7; and
both the first deconvolutional layer and the second deconvolutional layer have convolution kernel sizes of 2×2.

16. The electronic device according to claim 13, wherein the higher-order polynomial equation is a quartic polynomial equation.

17. The electronic device according to claim 13, wherein the step of generating a two-dimensional label matrix based on the sonar echo signal sample data and each higher-order polynomial equation comprises:
traversing all data points in the sonar echo signal sample data using a double-loop traversal method, and calculating an absolute value of a difference between a y-axis coordinate of a corresponding position of each data point and each equation value corresponding to the data point, to obtain a target distance, wherein the equation value is calculated by substituting an x-axis coordinate of the corresponding position of the data point into the higher-order polynomial equation; and
if the data point has a target distance less than a preset threshold, setting a label value corresponding to the data point in the two-dimensional label matrix to a first value; or
if the data point does not have a target distance less than a preset threshold, setting a label value corresponding to the data point in the two-dimensional label matrix to a second value.

18. The electronic device according to claim 13, wherein after the step of acquiring sonar echo signal sample data, the method further comprises:
performing three-dimensional image reshaping on the sonar echo signal sample data to obtain sample data to be processed; and
performing geometric transformations and Gamma correction on the sample data to be processed to obtain the sonar image sample data.

19. A non-transitory computer-readable storage medium, wherein the non-transitory computer-readable storage medium stores a computer program, and when the computer program is executed by a processor, the steps of the wall recognition method for a sonar image according to claim 1 are implemented.

20. The non-transitory computer-readable storage medium according to claim 19, wherein the initial model sequentially comprises: an input layer, at least two feature extraction units, a feature fusion unit, a decoding unit, and a classification unit, wherein each of the feature extraction units is arranged in parallel;
the feature extraction unit sequentially comprises: a first convolutional layer, a first activation layer, a first batch normalization layer, a first max pooling layer, a second convolutional layer, a second activation layer, a second batch normalization layer, and a second max pooling layer; and
the decoding unit sequentially comprises: a first deconvolutional layer, a third activation layer, a third batch normalization layer, and a second deconvolutional layer.
